(19) United States
(12) Patent Application Publication
(10) Pub. No.: US 2012/0188378 A1
(43) Pub. Date: Jul. 26, 2012

(54) AUTOMATIC ANALYZING METHOD AND SYSTEM FOR TEST STRIPS

(75) Inventor: Hsiung Hsiao, HsinChu (TW)

(73) Assignees: Middleland Sensing Technology Inc., HsinChu City (TW); Hsiung Hsiao, Hsinchu City (TW)

(21) Appl. No.: 13/351,336

(22) Filed: Jan. 17, 2012

Related U.S. Application Data
(63) Continuation-in-part of application No. 13/109,095, filed on May 17, 2011.

(30) Foreign Application Priority Data
Jan. 20, 2011 (TW) 100102125
Aug. 26, 2011 (TW) 100130777

(51) Int. Cl. G06K 9/68; H04N 11/00; H04N 7/18

(52) U.S. Cl. 348/161; 382/218; 382/165; 348/E11.001; 348/E07.087

(57) ABSTRACT

An exemplary automatic analyzing method for test strips includes steps of: providing a test strip unit having a reacting region and an image calibration region; capturing an image of the test strip unit including an image of the reacting region and an image of the image calibration region; analyzing the image of the test strip unit to generate a first image signal of the image calibration region and a second image signal of the reacting region; comparing the first image signal with a standard signal to generate an image signal calibration parameter; calibrating the second image signal by applying the image signal calibration parameter to generate a third image signal; and comparing the third image signal with data in a database to generate a corresponding parameter value. An automatic analyzing system for test strips is also provided.

### CROSS-REFERENCE TO RELATED APPLICATIONS

This application is a continuation in part of U.S. patent application Ser. No. 13/109,095, filed May 17, 2011, the entire contents of which are incorporated herein by reference.

### TECHNICAL FIELD

The present invention relates to an analyzing system for test strips and an analyzing method thereof, and more particularly to an automatic analyzing system for test strips and an automatic analyzing method thereof.

### BACKGROUND OF THE INVENTION

A conventional test strip kit includes a standard color interpretation table and test strips with reacting regions. The standard color interpretation table is consisted of a plurality of standard colors and a plurality of parameter values corresponding to the standard colors. The reacting region of a test strip is consisted of multiple reagent pads used to contact with a sample fluid, and color of the reacting regions will be correspondingly changed according to concentration of certain constituent of the fluid.

When a user uses the conventional test strip, generally, the sample fluid contacts with the reagent pads of the reacting region. After the reaction is completed, the color of each reagent pad is compared with the standard colors of the color interpretation table, and corresponding parameter values can be determined.

The above steps of reading a test strip rely on manual work, which is not only time-consuming but also has a large possibility of artificially misreading. A test strip scanning machine can also be used for color reading in an automatic way. However, a test strip is read by a light scanning process, in order to assure accuracy of scanning results, test strip scanners generally have large sizes and expensive components, hence, reducing their convenience and popularity.

### SUMMARY OF THE INVENTION

The present invention provides an automatic analyzing method for test strips to improve accuracy of analyzing accuracy.

The present invention provides an automatic analyzing system for test strips to improve accuracy of analyzing accuracy.

The present invention provides an automatic analyzing method for test strips to improve analyzing accuracy and analyzing efficiency.

The present invention provides an automatic analyzing system for test strips to improve analyzing accuracy and analyzing efficiency.

The present invention provides an automatic analyzing method for test strips which includes steps of: providing a test strip unit having a reacting region and an image calibration region; capturing an image of the test strip unit which includes an image of the reacting region and an image of the image calibration region; analyzing the image of the test strip unit to generate a first image signal of the image calibration region and a second image signal of the reacting region; comparing the first image signal with a standard signal to generate an image signal calibration parameter; calibrating the second image signal by applying the image signal calibration parameter to generate a third image signal; and comparing the third image signal with data in a database to obtain a corresponding parameter value.

The present invention further provides an automatic analyzing system for test strips which includes a test strip unit, an image capturing unit and a signal processing unit. The test strip unit includes a reacting region and an image calibration region. The image capturing unit is configured to capture an image of the test strip unit. The image of the test strip unit includes an image of the reacting region and an image of the image calibration region. The signal processing unit is electrically connected to the image capturing unit and is configured to analyze the image of the image calibration region to generate an image signal calibration parameter and calibrate the image of the reacting region by applying the image signal calibration parameter.

The present invention still further provides an automatic analyzing method for test strips which includes steps of: providing a test strip unit having a reacting region; capturing an image of the test strip unit which includes an image of the reacting region; analyzing the image of the test strip unit to generate an image signal of the reacting region; calibrating the image signal by applying an image signal calibration parameter to generate a calibration image signal; and comparing the calibrated image signal with data in a database to generate a corresponding parameter value.

The present invention still further provides an automatic analyzing system for test strips which includes a test strip unit, an image capturing unit, a storage unit and a signal processing unit. The test strip unit includes a reacting region. The image capturing unit is configured to capture an image of the test strip unit which includes an image of the reacting region. The storage unit is configured to store an image signal calibration parameter. The signal processing unit is electrically connected to the image capturing unit and the storage unit, and is configured to calibrate the image of the reacting region by applying the image signal calibration parameter.

In summary, by imparting the image signal calibration parameter, as a reference for calibrating the image of the reacting region image, through comparing the image of the comparison region of the test strip unit and the standard signal, the present invention reduces a captured color difference, which is caused by various image capture units, so as to increase the analyzing accuracy of a test strip. Moreover, in the present invention, a reaction region image captured from a test strip unit can be calibrated by a preinstalled image signal calibration parameter, and thereby the present invention has a higher accuracy for the analyzing of a test strip. Besides, because the images signal calibration parameter is preinstalled so as no need to perform a comparison to obtain the image signal calibration parameter, the present invention has a higher efficiency for the analyzing of a test strip. The automatic analyzing system for test strip of the present invention has a low cost and a small size. The automatic analyzing system for test strips can be widely used in mobile phones, personal digital assistants (PDA), portable personal computers or other electronic devices, which increases mobility and convenience.

### BRIEF DESCRIPTION OF THE DRAWINGS

The above objects and advantages of the present invention will become more readily apparent to those ordinarily skilled in the art after reviewing the following detailed description and accompanying drawing, in which:

FIG. 1 is a schematic view of an automatic analyzing system for test strips according to an embodiment of the present invention;

FIG. 2 is a schematic flow chart of an automatic analyzing method for test strips according to an embodiment of the present invention;

FIG. 3 is a schematic diagram illustrating an image capturing unit capturing an image of a test strip unit and a process of calibrating an image distortion of the captured image;

FIG. 4 is a schematic diagram of comparing an image signal an image with a standard signal to obtain an image signal calibration parameter;

FIG. 5 is a schematic view of an automatic analyzing system for test strips according to another embodiment of the present invention; and

FIG. 6 is a schematic flow chart of an automatic analyzing method for test strips according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

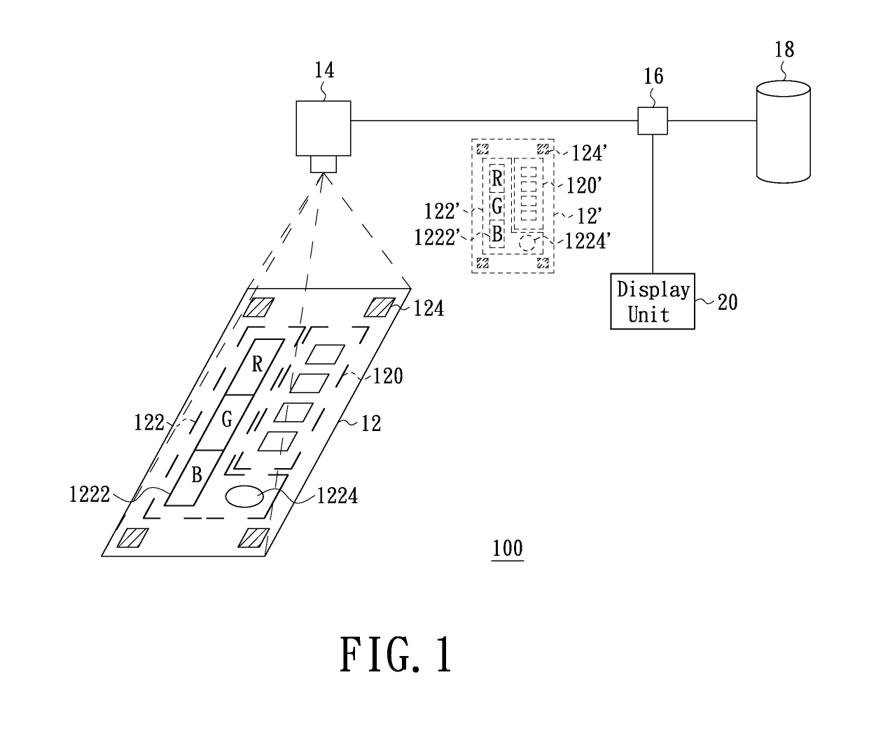

FIG. 1 is a schematic diagram of an automatic analyzing system for test strips in accordance with an embodiment of the present invention. As depicted in FIG. 1, the automatic analyzing system for test strips 100 includes a test strip unit 12, an image capturing unit 14 and a signal processing unit 16 electrically connected to the image capturing unit 14. The test strip unit 12 includes a reacting region 120 and an image calibration region 122. The image calibration region 122 for example includes a color-capturing calibration region 1222 and a sample color calibration region 1224; or, the image calibration region 122 may only include either the color-capturing calibration region 1222 or the sample color calibration region 1224 in other embodiments.

In the present embodiment, the test strip unit 12 is an allochroic test strip; that is, in a detecting process, the reacting region 120 will have a color variation in response to an interaction between the reacting region 120 and a tested object (not shown). Herein, the tested object for example is a sample fluid, and generally the color presented in the reacting region 120 is affected by a concentration of a tested material in the sample fluid.

In addition, color of the sample fluid itself may also affect the color presented in the reacting region 120 while the test strip unit 12 is being analyzed. For example, if the sample fluid is urine, the color of the urine itself definitely will affect the color presented in the reacting region 120 thereby causing misreading. Therefore, in the present embodiment, the sample color calibration region 1224 is configured to show the color of the sample fluid itself while is being contacted by the sample fluid, and the shown color is then used as a calibration data for the reading of the reacting region 120. Detail calibration method will be described in the following embodiment of an automatic analyzing method for test strips.

Moreover, as depicted in FIG. 1, the test strip unit 12 includes the color-capturing calibration region 1222 and the sample color calibration region 1224, wherein the color-capturing calibration region 1222 may include a plurality of color regions. The color regions at least include three primary color regions of red, green and blue. In the present embodiment, except the three primary color regions of red, green and blue, the color-capturing calibration region 1222 can also include color regions with the combinations of the three primary colors. Additionally, the color-capturing calibration region 1222 can be a standard color region standing for any concentration of certain constituent of the sample fluid.

Furthermore, the image capturing unit 14 can be a photographic assembly or an image scanning assembly.

Besides, the automatic analyzing system for test strips 100 may further include a display unit 20, which is electrically connected to the signal processing unit 16 and is configured to output a result signal previously processed by the signal processing unit 16.

The automatic analyzing system for test strip 100 may further include a storage unit 18, which is electrically connected to the signal processing unit 16. The storage unit 18 is configured to store a standard signal. The standard signal may include a standard color signal, a background color signal, and a parameter list or an equation, which together are used to be compared with an image of the image calibration region 122. Specifically, the standard color signal is configured to determine color shifts of the colors captured by the image capturing unit 14; the background color signal is configured to determine the color of the sample fluid itself; the parameter list or the equation is configured to record a corresponding relation between an image signal and a reading of the test strip. Besides, the storage unit 18 can be integrated into the signal processing unit 16 in another embodiment.

In addition, the test strip unit 12 may further include a plurality of positioning and alignment marks 124. In an embodiment, the number of the positioning and alignment marks 124 is three or more. These positioning and alignment marks 124 are disposed on a periphery area of the test strip unit 12 and configured to assist the signal processing unit 16 to position, so the signal processing unit 16 can perform the image keystone correction on the image 12′ of the test strip unit 12 when processing the image signal of the test strip unit 12. Detail function of the positioning and alignment marks 124 will be described in the following automatic analyzing method for test strips.

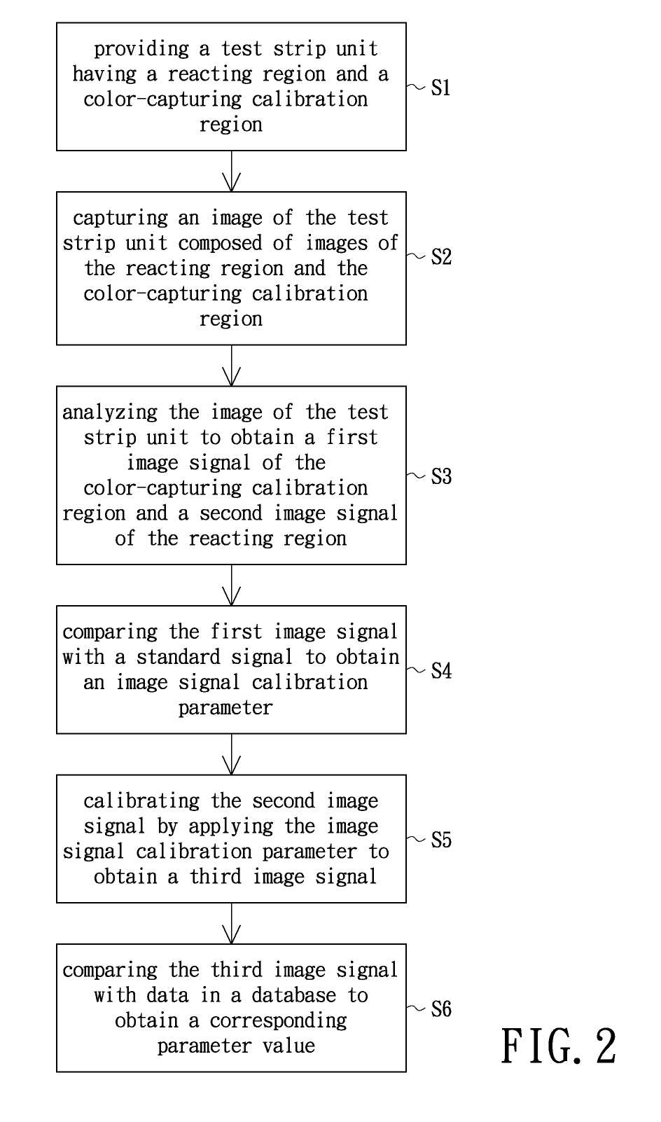

FIG. 2 is a schematic flow chart of an automatic analyzing method for test strips in accordance with one embodiment of the present invention. Referring to both FIG. 1 and FIG. 2, the automatic analyzing method for test strips according to an embodiment of the present invention has steps described below.

Firstly, as shown in step S1 of FIG. 2, the test strip unit 12 having the reacting region 120 and the image calibration region 122 is provided, and the sample fluid is contacted to the reacting region 120 so as to result in an interaction between the sample fluid and the reacting region 120.

After that, as shown in step S2, an image 12′ of the entire test strip unit 12 is captured by the image capturing unit 14. The image 12′ includes an image 122′ of the image calibration region 122 and an image 120′ of the reacting region 120. In addition, the image 12′ may further include images 124′ of the positioning and alignment marks 124 in one embodiment of the test strip unit 12 having the positioning and alignment marks 124.

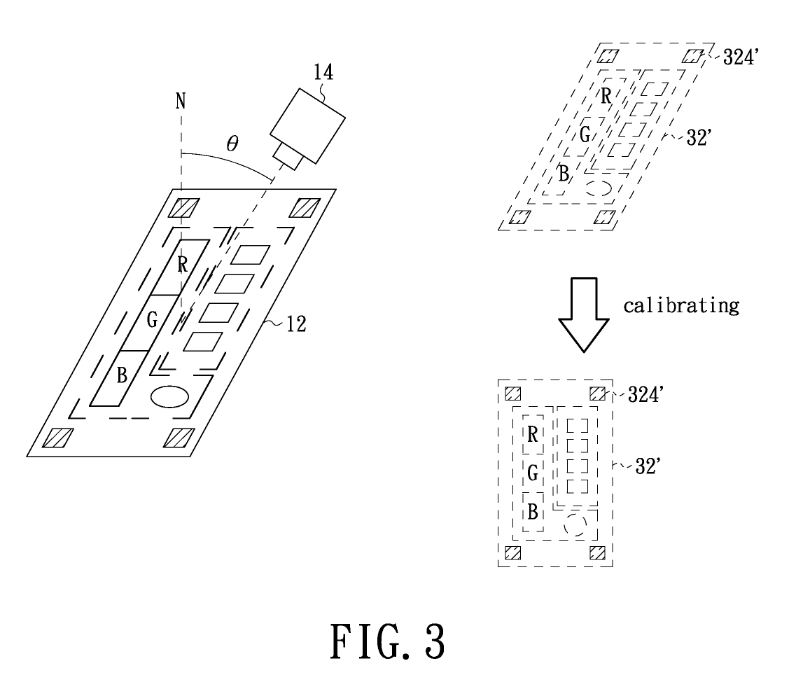

As shown in step S3, the image 12′ of the entire test strip unit 12 is transmitted to the signal processing unit 16, and thereby a first image signal of the image calibration region 122 and a second image signal of the reacting region 120 are respectively generated through the signal processing unit 16 analyzing the image 12′ of the entire test strip unit 12. Specifically, the position information of the positioning and alignment marks 124 is firstly identified in the aforementioned step of analyzing the image 12′. In the present embodiment, the images 124′ of the positioning and alignment marks 124 are located on corners of the image 12′ of the test strip unit 12, and thereby the signal processing unit 16 can use them to position the image 120′ of the reacting region 120 and the image 122′ of the image calibration region 122 in the image 12′ of the test strip unit 12. The determination of the positions of the images of the reacting region and image calibration region by the images of the positioning and alignment marks is described in detail in FIG. 3. As shown in FIG. 3, when the image capturing unit 14 captures an image of the test strip unit 12, the captured image 32′ of the test strip unit 12 may have an image distortion if an angle θ existing between a normal direction of the test strip unit 12 and the image capturing unit 14. Therefore, the signal processing unit 16 can use the images 324′ of the positioning and alignment marks to correct the image 32′ of the test strip unit 12 from the image distortion. In other words, through the position relationships between these images 324′ of the positioning and alignment marks, the signal processing unit 16 can eliminate the effect of the image distortion so as to obtain an image 32′ of the test strip unit 12 without the image distortion, and thereby the image 120′ of the reacting region 120 and the image 122′ of the image calibration region 122 are positioned with a higher accuracy. It is noted that the step of calibrating the image distortion can be skipped.

Still as shown in step S3 of FIG. 2, the signal processing unit 16 then analyzes the image 122′ so as to generate the first image signal. Specifically, in the embodiment that the image 122′ of the image calibration region 122 includes an image 1222′ of the color-capturing calibration region 1222 and an image 1224′ of the sample color calibration region 1224, the signal processing unit 16 generates an image signal of the color-capturing calibration region 1222 and an image signal of the sample color calibration region 1224 through analyzing the image 1222′ of the color-capturing calibration region 1222 and the image 1224′ of the sample color calibration region 1224, respectively. Herein, the aforementioned first image signal includes the image signals of the color-capturing calibration region 1222 and the sample color calibration region 1224. The signal processing unit 16 also analyzes the image 120′ to generate an image signal of the reacting region 120, which is referred as a second image signal. In the present embodiment, the image signals of the color-capturing calibration region, the sample color calibration region and the reacting region are pixel signals of red, green and blue (RGB pixel signal). In addition, it is noted that the first image signal may only consist of the image signal either of the color-capturing calibration region or the sample color calibration region in an embodiment of the image calibration region 122 only including either the color-capturing calibration region 1222 or the sample color calibration region 1224.

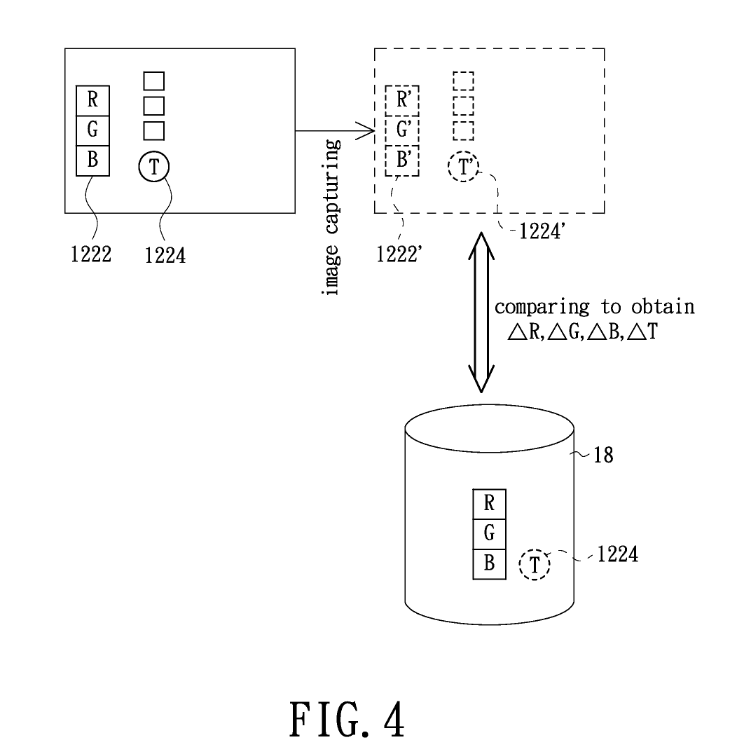

As shown in step S4, the first image signal is compared with the standard signal so as to obtain the image signal calibration parameters. As mentioned above, the standard signal for example includes the standard color signal and the background color signal in the present invention. Specifically, as mentioned above, the color-capturing calibration region 1222 is consisted of the plurality of color regions with different colors. Therefore, as shown in step S5 of FIG. 2, after obtaining the image signal of each color region, the signal processing unit 16 compares the image signal of the color-capturing calibration region 1222 with the standard color signal stored in the storage unit 18, so as to obtain capturing calibration parameters of each color region. As shown in FIG. 4, in the present embodiment, the color-capturing calibration region 1222 of the test strip unit 12 includes the red region, the blue region and the green region. The image signals of the red region, the blue region and the green region of the image 1222′ captured by the image capturing unit 14 are respectively R′, G′ and B′. The image processing unit compares the image signals R′, G′ and B′ with the standard color signals R, G and B stored in the storage unit 18, so as to respectively obtain a red capturing calibration parameter ΔR, a green capturing calibration parameter ΔG and a blue capturing calibration parameter ΔB. In the embodiment, the red capturing calibration parameter ΔR, the green capturing calibration parameter ΔG and the blue capturing calibration parameter ΔB are consisted in the color-capturing calibration parameter.

Next, the color-capturing calibration parameter is applied to an image signal T′ of a sample color calibration region 1224. The image signal of the sample color calibration region 1224, applied with the color-capturing calibration parameter, is compared with the background color signal T stored in the storage unit 18, so as to obtain an sample color calibration parameter ΔT. In the present embodiment, the image signal calibration parameters for example include the color-capturing calibration parameter and the sample color calibration parameter. The image signal calibration parameter may only consist of either the color-capturing calibration parameter or the sample color calibration parameter in the embodiment of the image calibration region 122 only comprising either the color-capturing calibration region 1222 or the sample color calibration region 1224.

Then, as shown in step S5 of FIG. 2, the second image signal is calibrated by applying the image signal calibration parameter so as to generate a third image signal. That is, the third image signal is generated through applying the color-capturing calibration parameter and the sample color calibration parameter to the second image signal of the image 120′ of the reacting region 120. Herein, the third image signal is referred as a calibration image signal.

As shown in step S6, the third image signal is compared with data in the database so as to generate a corresponding parameter value. As mentioned above, the database for example is a parameter list or an equation which is stored in the storage unit 18 in advance. The obtainment of the corresponding parameter value can be implemented through comparing the third image signal with the parameter list or introducing the third image signal into the equation.

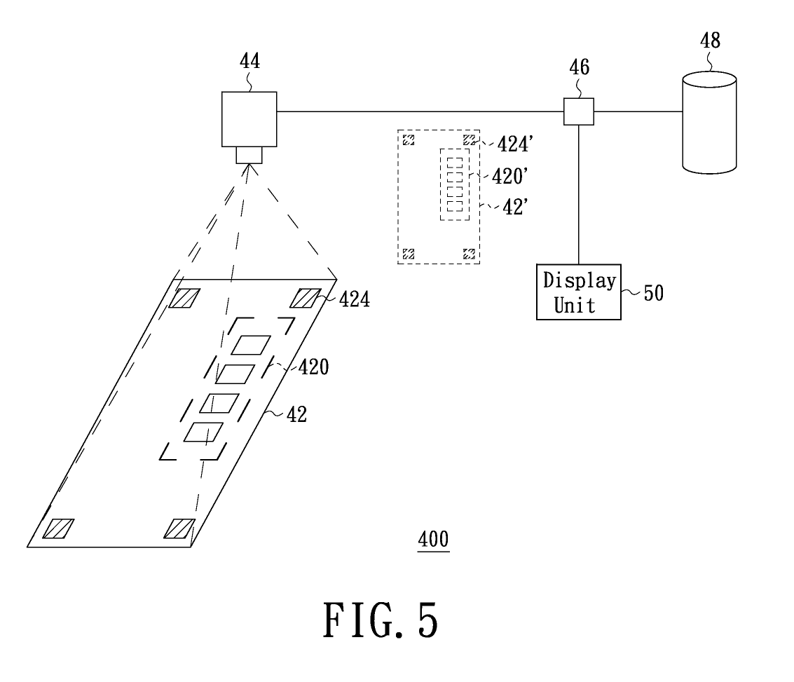

FIG. 5 is a schematic diagram of an automatic analyzing system for test strips in accordance with another embodiment of the present invention. As depicted in FIG. 5, the automatic analyzing system for test strips 400 includes a test strip unit 42, an image capturing unit 44, a signal processing unit 46 and a storage unit 48. The signal processing unit 46 is electrically connected to the image capturing unit 44 and the storage unit 48.

The test strip unit 42 is similar to the aforementioned test strip 12 except without an image calibration region. The reacting region 420 of the test strip unit 42 has functions similar to that of the aforementioned reaction region 120, and thereby no any unnecessary detail will be given here. The image capturing unit 44 is configured to capture an image of the test strip unit 42, which is primarily constructed by the image of the reaction region 420. The storage unit 48 is configured to store an image signal calibration parameter; and the signal processing unit 46 is configured to calibrate the image of the reacting region 420 by applying the image signal calibration parameter.

Similar to the aforementioned automatic analyzing system for test strips 100, the automatic analyzing system for test strips 400 may further include a display unit 50 electrically connected to the signal processing unit 46; and the test strip unit 42 may further include a plurality of positioning and alignment marks 424.

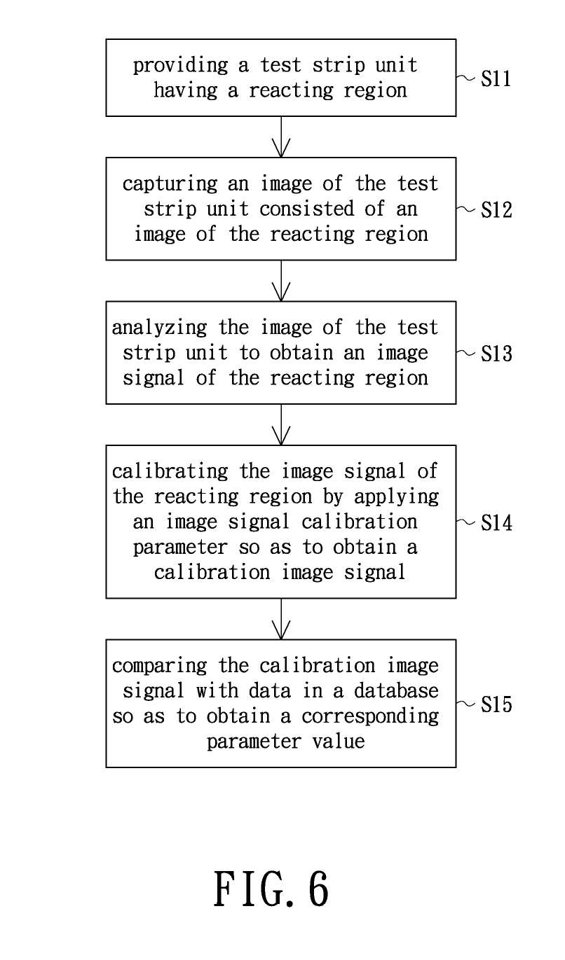

FIG. 6 is a schematic flow chart of an automatic analyzing method for test strips in accordance with another embodiment of the present invention. Referring to both FIG. 5 and FIG. 6, the automatic analyzing method for test strips according to another embodiment of the present invention has steps described below.

Firstly, as shown in step S11 of FIG. 6, the test strip unit 42 having the reacting region 420 is provided, and the sample fluid is contacted to the reacting region 420 so as to result in an interaction between the sample fluid and the reacting region 420.

Then, as shown in step S12, an image of the entire test strip unit 42 is captured by the image capturing unit 44, wherein image of the entire test strip unit 42 includes an image of the reacting region 420.

Then, as shown in step S13, the image of the entire test strip unit 42 is transmitted to the signal processing unit 46, and thereby an image signal of the reacting region 420 is generated through analyzing the image of the entire test strip unit 42. Herein, the RGB pixel signal of the image of the reacting region 420 is analyzed in the step of analyzing the image of the test strip unit 42 for the obtainment of the image signal of the reacting region 420. Besides, similar to the aforementioned embodiment depicted in FIG. 2, position information of the positioning and alignment marks 424 is identified in the step of analyzing the image of the test strip unit 42. The process of identifying the position information of the positioning and alignment marks 424 will become more readily apparent after reviewing the aforementioned automatic analyzing method for test strips depicted in FIG. 2.

Then, as shown in step S14, the image signal is calibrated by the image signal calibration parameter to generate a calibration image signal. More specifically, the signal processing unit 46 generates the calibration image signal through calibrating the image signal of the reacting region 420 by applying the image signal calibration parameter. The image signal calibration parameter is stored in the storage unit 48 in advance.

Then, as shown in step S15, a corresponding parameter value is obtained through comparing the calibration image signal with data in a database. This step S15 is similar to the step S6 in FIG. 2, no any unnecessary detail will be given here.

In the embodiment of the automatic analyzing system 400 and method for test strips, because the storage unit 48 is stored with the image signal calibration parameter in advance, and thereby the step S4 in the FIG. 2, for generating the image signal calibration parameter, can be skipped in the embodiment so as the efficiency of analyzing the test strip unit 42 is enhanced consequently. Besides, the automatic analyzing system for test strip 400 further has an advantage of lower cost due to without the image calibration region in the test strip unit 42. In addition, the analyzing accuracy of the test strip unit 42 can be maintained through updating the image signal calibration parameter preinstalled in the storage unit 48, regularly or occasionally. To get a clearly understanding of the process of the obtaining or the calibration of the image signal calibration parameter, please referring to the steps S1 to S4 in FIG. 2; however, it is to be understood that the embodiment needs not be limited by these steps.

In summary, the present invention provides an automatic analyzing method for test strips which uses the positioning and alignment marks in the test strip unit to correct the image of the test strips from the image distortion, thereby improving accuracy of reading value of the test strips and avoiding a misreading problem caused by an image with distortion and wrong positioning.

Moreover, the present invention further provides an analyzing method which compares the image of the image-capturing calibration region of the test strip unit with the standard parameters so as to obtain calibration parameters used as a basis for calibrating the reacting region. In such way, the effects of chromatic aberration generated by the image capturing unit and the color of the sample fluid itself can be reduced, so that availability of the automatic analyzing system can be promoted.

Furthermore, the present invention still further provides an automatic analyzing system and method for test strips with the pre-stored image signal calibration parameter. Therefore, the automatic analyzing process for test strips can be simplified, and thereby the analyzing efficiency is increased consequently. In addition, the automatic analyzing system for test strips has a further lower cost due to the image calibration region is not needed to be arranged in a test trip unit.

Therefore, the automatic analyzing system for test strips of the present invention has a low cost and a small size. The automatic analyzing system for test strips can be widely used in mobile phones, personal digital assistants (PDA), portable personal computers or other electronic devices, which increases mobility and convenience.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic analyzing method for test strips, comprising steps of:
providing a test strip unit having a reacting region and an image calibration region;
capturing an image of the test strip unit, the image of the test strip unit comprising an image of the reacting region and an image of the image calibration region;
analyzing the image of the test strip unit to generate a first image signal of the image calibration region and a second image signal of the reacting region;
comparing the first image signal with a standard signal to generate an image signal calibration parameter;
calibrating the second image signal by applying the image signal calibration parameter to generate a third image signal; and
comparing the third image signal with data in a database to obtain a corresponding parameter value.

2. The automatic analyzing method for test strips according to claim 1, wherein the image calibration region comprises a color-capturing calibration region and/or a sample color calibration region, and the first image signal comprises an image signal of the color-capturing calibration region and/or an image signal of the sample color calibration region.

3. The automatic analyzing method for test strips according to claim 2, wherein the image signal calibration parameter comprises a color-capturing calibration parameter and/or a sample color calibration parameter.

4. The automatic analyzing method for test strips according to claim 1, wherein the standard signal comprises a standard color signal and/or a background color signal.

5. The automatic analyzing method for test strips according to claim 1, wherein in the step of analyzing the image of the test strip unit to generate the first image signal and second image signal, pixel signals of red, green and blue of the image of the test strip unit are analyzed.

6. The automatic analyzing method for test strips according to claim 1, wherein in the step of analyzing the image of the test strip unit, position information of a plurality of positioning and alignment marks of the test strip unit is identified.

7. The automatic analyzing method for test strips according to claim 6, further comprising a step of defining the image of the image calibration region and the image of the reacting region based on the position information of the positioning and alignment marks.

8. The automatic analyzing method for test strips according to claim 6, further comprising a step of calibrating a distortion of the image of the test strip unit by the position information of the positioning and alignment marks.

9. An automatic analyzing system for test strips, comprising:
a test strip unit having a reacting region and an image calibration region;
an image capturing unit configured to capture an image of the test strip unit, the image of the test strip unit comprising an image of the reacting region and an image of the image calibration region; and
a signal processing unit electrically connected to the image capturing unit and configured to analyze the image of the image calibration region to generate an image signal calibration parameter and calibrate the image of the reacting region by applying the image signal calibration parameter.

10. The automatic analyzing system for test strips according to claim 9, wherein the image calibration region comprises a sample color calibration region and/or a color-capturing calibration region.

11. The automatic analyzing system for test strips according to claim 9, further comprising a display unit electrically connected to the signal processing unit.

12. The automatic analyzing system for test strips according to claim 9, wherein the test strip unit further comprises a plurality of positioning and alignment marks.

13. The automatic analyzing system for test strips according to claim 9, further comprising a storage unit electrically connected to the signal processing unit and configured to store at least a standard signal.

14. An automatic analyzing method for test strips, comprising steps of:
providing a test strip unit having a reacting region;
capturing an image of the test strip unit, the image of the test strip unit comprising an image of the reacting region;
analyzing the image of the test strip unit to generate an image signal of the reacting region;
calibrating the image signal by applying an image signal calibration parameter to generate a calibration image signal; and
comparing the calibration image signal with data in a database to generate a corresponding parameter value.

15. The automatic analyzing method for test strips according to claim 14, wherein in the step of analyzing the image of the test strip unit to generate the image signal, a red pixel signal, a green pixel signal and a blue pixel signal of the image of the test strip unit are analyzed.

16. The automatic analyzing method for test strips according to claim 14, wherein in step of analyzing the image of the test strip unit, position information of a plurality of positioning and alignment marks of the test strip unit is identified.

17. The automatic analyzing method for test strips according to claim 16, further comprising a step of calibrating a distortion of the image of the test strip unit by the position information of the positioning and alignment marks.

18. An automatic analyzing system for test strips, comprising:
a test strip unit having a reacting region;
an image capturing unit configured to capture an image of the test strip unit, the image of the test strip unit comprising an image of the reacting region;
a storage unit configured to store an image signal calibration parameter; and
a signal processing unit electrically connected to the image capturing unit and the storage unit and configured to calibrate the image of the reacting region by applying the image signal calibration parameter.

19. The automatic analyzing system for test strips according to claim 18, further comprising a display unit electrically connected to the signal processing unit.

20. The automatic analyzing system for test strips according to claim 18, wherein the test strip unit further comprises a plurality of positioning and alignment marks.
